(19) United States
(12) Patent Application Publication
(10) Pub. No.: US 2004/0057072 A1
(43) Pub. Date: Mar. 25, 2004

(54) Network printer driver pre-configuration for downloading and installation

(76) Inventors: Gregory E. Borchers, Vancouver, WA (US); Scott C. Koss, Vancouver, WA (US); Rono J. Mathieson, Camas, WA (US)

Correspondence Address: David C. Ripma, Patent Counsel, Sharp Laboratories of America, Inc., 5750 NW Pacific Rim Boulevard, Camas, WA, 98607, US

(21) Appl. No.: 10/254,060

(22) Filed: Sep. 23, 2002

(51) Int. Cl. G06F 9/445; G06F 13/10

(52) U.S. Cl. 358/1.15; 719/321; 717/176

(57) ABSTRACT

A web-based network system and methodology involving the full pre-configuring and making available for downloading and installation of appropriate printer-drivers for plural network-available printing devices extant in a web-based network system. Drivers are either pre-configured and readied for delivery at a point in time well in advance of a user's call for the downloading and installation of a printer-device driver, or such drivers are pre-configured effectively as a consequence of a user call for downloading and installation, and at a moment in time which is just immediately prior to downloading-delivery and installation.

### BACKGROUND OF SUMMARY OF THE INVENTION

This invention pertains to network printer-driver management, and in particular, to a web-based network system and methodology that involve the “pre-delivery” preparation (before downloading and installation) of fully pre-configured printer drivers which are readied, at a network-common consolidation site, for delivery to requesting user work stations seeking to use selected network-available printing devices. It also relates, in a somewhat modified form, to such a system and methodology which operates in a kind of “on call” manner, wherein printer drivers for installation to users' work stations are configured for delivery and installation on the occurrence, and as a consequence, of a user's call for such a delivery and installation.

Fundamentally, the present invention is aimed at dealing with a conventional network situation which is that tools and methods have not been made available that allow for efficient centralizing and managing (configuring and installing) of printer drivers needed for a multiplicity of available network printing device. More specifically, the task currently of properly configuring and installing such drivers to network users' work stations is most often accomplished in a kind of case-by-case fashion which is quite time consuming, inefficient and inconvenient. In particular, the configuring and installing of printer drivers is often performed by a manager of information systems whose valuable time must also be employed to address many other important network issues.

Mentioning just a few representative definers of current inefficiency and inconvenience, while local printing-device monitoring tools can configure the various options provided in printer driver settings on a work-station by work-station basis, and at a point in time after a particular printer driver has already been installed, remote printer-device administration tools do not typically have the capability to change the printer-driver settings of existing locally installed printer drivers. Further, remote administration tools typically do not currently have the capability to pre-configure and to change printer settings for drivers that are being downloaded and installed in users' work stations.

The present invention uniquely handles this printer-driver situation in what can be thought of as two phases of behavior. The first involves the pre-configuring of specific printer drivers for downloading and installation to specific, functionally associated, network-available printing devices. This pre-configuring takes place following appropriate network collecting and documenting of the relevant structural and operational characteristics of network-available printing devices. The second phase of behavior involves the making available of these pre-configured drivers to different users for downloading and installation to their respective work stations. Pre-configuring can be performed either well in advance of a user's call for downloading and installation, or immediately after, and as a consequence of, such a call.

The system and methodology of the present invention additionally feature a 20 strong web-based characteristic, whereby information managers and work-station users can employ the advantages of the invention via web-based network interfaces (web browsers), and http-protocol communication.

Lying at an early stage in the practice and implementation of the present invention is the allowance which is provided for remote printer administration tools, either automatically, or under the command and control of an information services administrator, to learn about and assess the existing hardware characteristics and configurations of network-available printers. This learning process provides a basis, in accordance with practice of the present invention, for fully preparing and configuring appropriate network printer drivers before driver installations actually take place at user work stations. Various characteristics of printing devices are assessed in this process, including, as an illustration and without limit, such things as RAM configurations, the presence or absence of so-called job finishers, print queue names, assigned IP addresses, and other things. With this kind of information at hand, practice of the present invention allows for efficient pre-configuring of printing device drivers, either just immediately before downloading and installation (i.e. when a user calls for a driver installation at his or her work station), or at times much earlier, depending upon how a system administrator wishes to manage the handling of printer-driver characteristics.

Various other features and advantages which characterize this invention will become more fully apparent as the description that now follows is read in conjunction with the accompanying drawing.

### DESCRIPTION OF THE DRAWING

FIG. 1, the single drawing figure herein, is a simplified and somewhat fragmentary block/schematic diagram illustrating a printer-driver management, web-based system and methodology constructed, and operable, in accordance with the present invention.

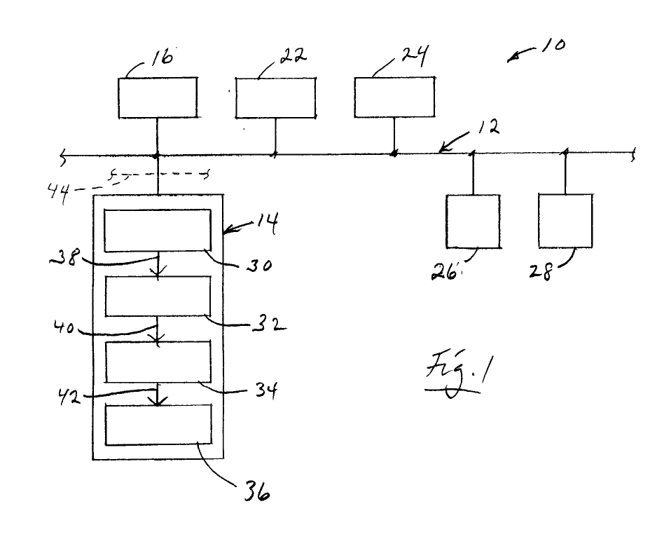

### DETAILED DESCRIPTION OF THE INVENTION

Turning now to the single drawing figure, indicated generally at 10 is a web-based network system which is constructed for operation in accordance with a preferred form of the present invention. Network 10 includes an appropriate data-communication structure 12, which, as specifically illustrated herein for exposition purposes, takes the form of a local-area, hardwired network that might be resident, for example, within a single particular building. It should be understood that while a specific local-area network has been chosen herein for illustration purposes, other kinds of web-based network configurations, could be employed just as well to practice the invention. For example, a network involving multiple distributed extensions over a large geographic area, such as within a large office complex, might be involved, as could also a much larger area network of the kind that includes longer-distance Internet-type connectivity. As will become apparent, the features and utility of the present invention do not necessarily depend upon the nature of the specific web-based network which is involved. All that is required is that, at appropriate times which will become apparent, full network-communication connectivity be in existence between different network devices.

Included in network 10, in addition to the data-communication structure just mentioned, is a web-based administration server 14 which is configured to operate in accordance with the present invention, and which is directly accessible over the network through a web-based user interface 16 that is connected to communication structure 12. This interface is provided so that a system manager (administrator) can perform, among other things, certain tasks in relation to printer-driver management in accordance with the present invention. Server 14 is also referred to herein as a driver-management, web-based server site, and as a network-connected site.

Further included in network system 10 are two (a population of) network-available printers, or printing devices, 22, 24, which herein each takes the form of a so-called multi-function printing (MFP) device. It also includes two web-based user computer work stations and interfaces 26, 28, hereinafter referred to simply as work stations or as interfaces. For the purpose of illustrating the performance characteristics of the present invention in the environment of network 10, it is assumed that the respective users of interfaces 26, 28 wish to make use of the printing capabilities of one or both of devices 22, 24.

Obviously, if the work stations which are associated with interfaces 26, 28 are to have the opportunity to use the resources of devices 22, 24, these work stations must be correctly equipped with appropriate, respective, full-function printer drivers for these printing devices. It is in relation to arming and enabling these two user work stations selectively to make use of devices 22, 24 that the present invention makes its special contribution in system 10.

Included within server 14 in the system embodiment now being described, are four blocks shown at 30, 32, 34, 36. Respective functional flow connections between these internal blocks are illustrated by arrows 38, 40, 42. Block 30 represents an available repository of printing-device specific information, including the identities, characteristics and network addresses of printing devices 22, 24, and also including information specifying appropriate drivers and driver installation data relating to these printing devices. Block 32 is a selection-enabling block which arms server 14, according to practice of the invention, to select information from block 30 in preparation for pre-configuring a driver for one of devices 22, 24. Block 34 is a configuration block wherein a driver/driver-installer for the selected device is/are prepared. Block 36 acts as a storage and delivery site for receiving, holding, and delivering, as required, pre-configured drivers.

Blocks 30-36, inclusive, constitute pre-configuration activity structure herein, blocks 30, 32, 34 as response structure, and block 36 constitutes a storage location. Block 36 is also referred to herein as a network-common consolidation site. The exact internal structures and operating characteristics of blocks 30-36 can take on any one or more of various conventional forms well within the knowledge and experience of those skilled in the art. Accordingly, details of the blocks are not elaborated herein.

Describing now a first stage, or phase, of operation and behavior of the present invention, as pictured in the drawing, in any appropriate manner, as by automatic behavior, or by virtue of a command given at interface 16 by a system administrator, web-based server 14 is enabled to gather, and does gather, information relating to the hardware and operational characteristics and configurations of the available network printing devices, such as MFP devices 22, 24. This is a point in time during which appropriate connectivity between devices 22, 24 and server 14 must exist via data-communication structure 12.

Accordingly, server 14 acquires this information, and effectively stores it in block 30 along with relevant printer-driver and installation data which the server must also gather, or have gathered, and stored.

At an appropriate point in time, which might be just after acquisition of hardware, etc. configuration information regarding devices 22, 24, server 14 performs several activities which are pictured within it in FIG. 2 in blocks 32, 34, 36. Preferably, the activities that take place in these three blocks occurs shortly after acquisition of the device-specific information just mentioned with regard to devices 22, 24.

With server 14 so armed with information within block 30, appropriate pre-configuration of installable drivers for devices 22, 24 takes place in either one of two different specific approaches. One approach involves full pre-configuration of the appropriate drivers essentially as soon as server 14 is armed with all of the appropriate information, thus to create early, and to store in block 36, pre-configured drivers using the interaction between block 36 and blocks 30, 32, 34. This can be done whether automatically, or manually under the control of a system administrator working at interface 16.

Another approach contemplated by the invention is one wherein driver pre-configuration, and storage for delivery from block 36, occur as a consequence of, and immediately after, a call by a user of the work stations associated with interfaces 26, 28 to install the appropriate driver for use of either one of printing devices 22, 24. In this second kind of approach, when a user calls for downloading and installation of a driver, say, for device 24, immediately after that call is communicated over structure 12 and received by server 14, the server, employing block 32, selects the appropriate driver from block 30, pre-configures it in block 34, and sends it to block 36 for immediate download delivery to the user work station from where the call came.

In both approaches, drivers appropriate to selected network printing devices are fully pre-configured prior to downloading and installation at a user's work station.

From the point of view of a user operating at one of the two work stations pictured in the drawing figure, the invention promotes the opportunity for that user, without having to perform any printer-driver configuring activities, to call for downloading and installation of a fully pre-configured and ready-to-use driver which is appropriately configured for the selected printing device.

What has just been described are phases of operation uniquely offered by the system and methodology of this invention relating to the full pre-configuring, and the making available for downloading and installation, of drivers for all intended network printing devices. The specific population of network printing devices chosen for “attention” by the present invention may, of course, be all, or less that all network connected printing devices. This is merely a matter of option and choice. The task of an administrator with respect to equipping a particular user work station with a driver or drivers for one or perhaps many selected printing devices is greatly simplified by the establishment of a consolidated, network-common delivery site from which preconfigured drivers just need to be called for by work-station users.

The system and operating methodology which has thus now been described for a preferred form and manner of practicing the invention have been illustrated and discussed in the setting of an otherwise conventional local area network, wherein there are no data-flow barriers, such as a firewall, in existence between printer-devices, user work stations, and a server, such as server 14. Looking again for a moment at the single drawing figure, shown generally and symbolically by a dashed line at 44 is one of any conventional variety of communication firewall. Relative to server 14, firewall 44 readily permits outgoing communication, but not the reverse. Such a firewall, of course, appropriately stands in the way of certain kinds of communications, but must effectively be out of the way at least at the time when server 14 is calling for the reporting to it of the appropriate hardware and capability configurations of the network printing devices whose drivers are to be pre-configured for delivery by the server. Such a firewall might well exist in many kinds of systems, such as Internet-connected systems, and it should be understood that the present invention can function appropriately even in that kind of a setting with appropriate steps taken to “open up” the firewall under circumstances where connectivity must be established for server 14 to perform its pre-configuration, incoming data-acquisition functions. No specific firewall or specific manner of selectively breaching such a wall, are disclosed herein, inasmuch as those skilled in the art will readily understand how to accomplish this for all kinds of different network systems having different firewalls. In the arrangement involving such a firewall, the firewall is referred to as a selectively breachable firewall.

The novel methodology of this invention as employed in a network can be viewed as including the steps of: (a) furnishing a driver-management, web-based server site from which a pre-configured device-specific printer driver for a selected, network-available printing device may be made available for downloading to, and installation in, the work station of a prospective network user of that device; (b) additionally, furnishing pre-configuration activity structure which is operatively associated with that server site; and (c) operating that activity structure to pre-configure an appropriate printer driver for the selected device for subsequent delivery of that driver through the site in order to implement a user's call for the downloading and installing of the driver to the user's associated work station.

The pre-configuration activity can be performed either well before the arrival of any “call” for downloading and installation, or immediately just after, and as a consequence of, such a call. The steps of the invention can be performed also in a network having a firewall, where that firewall is appropriately breachable with specific reference to operation of the invention.

Thus there has been disclosed, illustrated and described herein a novel system and methodology relating to the pre-configuration (before downloading and installation) of appropriate drivers for a population of network-available printing devices. Pre-configured drivers are conveniently and efficiently made available for delivery from a network-common consolidation site which is associated with a server that functions to implement the driver pre-configuration activities. Also clearly disclosed, illustrated and described herein is the opportunity which the system and methodology of the invention provide to users at their respective work stations to call for the installation and downloading of fully pre-configured drivers, without those users having to go through the process of driver configuration, and without necessitating the case-by-case intervention and tailoring of (and by) a system administrator to perform multiple, singular specific driver installations to a host of work stations.

Accordingly, while a preferred embodiment and manner of practicing the invention, and certain variations and modifications, have been illustrated, described and discussed herein, it is appreciated that other variations and modifications may be made without departing from the spirit of the invention.

I claim:

1. A web-based network system for selectively pre-configuring, before network downloading and installing to a user's work station, a printer driver for a selected, network-available printing device comprising
a driver-management, web-based server site from which a pre-configured, device-specific printer driver for the selected printing device may be made available for downloading to, and installation in, the work station of a prospective network user of that device, and
pre-configuration activity structure operatively associated with said site, operable to pre-configure an appropriate printer driver for the selected device for subsequent delivery of that driver through said site to implement a user's downloading and installing of the driver to the user's associated work station.

2. The system of claim 1 which is constructed in such a fashion that a stored, fully pre-configured printer driver for the selected network printing device is readied and available for delivery from a storage location through said site to a user's work station at a point in time which precedes a user's call for the downloading and installation of the driver.

3. The system of claim 1 which includes response structure which performs in such a fashion that a fully pre-configured printer driver for the selected network printing device is prepared for delivery through said site to a user's work station as a consequence of, and following, a user's call for the downloading and installation of the driver.

4. The system of claim 1, wherein a selectively breachable firewall exists between said site and the user's work station.

5. A web-based network system for pre-installation management of the configuration of printer drivers for specific network-available printing devices comprising
a network-connected site associated with a web-based server for storing and making available for downloading and installation selectively pre-configured printer drivers which are specific to respective, different network-available printing devices,
a network-connected population of such different printing devices, and
a network-connected, web-based user interface enabling user downloading and installing from said site to the user's work station of respective ones of such pre-configured printer drivers relative to respective associated ones of said printing devices.

6. A web-based network method for selectively pre-configuring, before network downloading and installing to a user's work station, a printer driver for a selected network-available printing device, said method comprising
furnishing a driver-management, web-based server site from which a pre-configured device-specific printer driver for the selected printing device may be made available for downloading to, and installation in, the work station of a prospective network user of that device, and
additionally, furnishing pre-configuration activity structure which is operatively associated with the mentioned site, and operating that structure to pre-configure an appropriate printer driver for the selected device for subsequent delivery of that driver through the site in order to implement a user's call for the downloading and installing of the driver to the user's associated work station.

7. The method of claim 6, wherein operation of said pre-configuration activity structure to pre-configure a driver takes place at a point in time which precedes a user's call for the downloading and installation of the driver.

8. The method of claim 6, wherein operation of said pre-configuration activity structure to pre-configure a driver takes place subsequent to, and as a consequence of, a user's call for downloading and installation of the driver.

9. The method of claim 6, wherein said furnishings take place on the common opposite side of a firewall relative to the location of the user's work station.
